(19) United States
(12) Patent Application Publication
(10) Pub. No.: US 2008/0034726 A1
(43) Pub. Date: Feb. 14, 2008

(54) REVERSIBLE DIRECTIBLE HARVESTING MACHINE AND METHOD FOR CARRYING OUT THE HARVESTING PROCESS WITH SAID MACHINE

(75) Inventor: PABLO MARTIN BONADEO, Santa Fe (AR)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Los Olivares de Venado Tuerto S.A.

(21) Appl. No.: 11/463,811

(22) Filed: Aug. 10, 2006

(30) Foreign Application Priority Data
Oct. 4, 2005 (AR) P050104189

(51) Int. Cl. A01D 46/253

(52) U.S. Cl. 56/328.1; 56/10.1

(57) ABSTRACT

This patent relates to a reversible, preferably riding harvesting machine with lateral operation that can be used for the mechanic harvesting of citric fruits such as oranges and other fruit crops planted in rows and a method for carrying out the harvesting process with this machine. This invention allows for a better maneuvering of the harvesting machine in small spaces, especially in crop headers, transportation thereof and adaptability to the different shapes of the land. Each one of the gears of said reversible harvesting machine is capable of inverting the direction of the turn thus allowing for harvesting in opposite directions, and the wheels can rotate substantially 90° or more to allow left or right lateral movement of the machine and change the crop row; the harvesting machine of the present invention comprises at least a cab, two seats that can swivel and slide so as to be in the best position in terms of the harvesting direction.

### BACKGROUND OF THE INVENTION

1. Field of the Invention

The present invention refers to a reversible, directible, preferably riding and laterally operated harvesting machine that can be used in the mechanical harvesting of citrus fruits such as oranges and other fruit crops planted in rows and a method for carrying out the harvesting process with said machine.

The present invention will increase the maneuverability of the harvesting machine in little spaces, especially in crop headers and intensive cultivation frames with little space in between rows, improve transportation and adaptation thereof to different land shapes, allowing at the same time, that heavy machines be operative in small spaces.

2. Description of the Related Art

A large number of harvesting machines are known in the prior art such as those disclosed in U.S. Pat. Nos. 5,904,034; 4,077,193; 4,329,836; 4,860,529; 4,974,404; 5,027,593; 5,161,358; 5,220,775; 5,421,149, 5,661,963; 5,904,034; 5,921,074; 6,003,294; 6,158,203; 6,070,402; 5,666,796; 5,660,033; 5,027,593; 5,010,719; 4,982,558; and 4,750,322.

The machines disclosed in said patents as well as those known up to date show significant downsides related to the maneuverability of the machine in the narrow paths of the cultivated fields as well as the ability of the machine to turn at the end of the rows or headers of the plantations, due to the short distances available.

This invention overcomes the problems existing in the prior art, especially in the turn to be made by the harvesting machine at the end of the row or header; where the machine needs to get around the elements adjacent to the plantation header.

Among the elements to be avoided, we mainly find plant health barriers, especially beefwood fences (placed to avoid canker and weather factors such as wind). In other places, the land shape grants very little header space which makes the turning maneuver very difficult at the end of the row. Other difficulties include the transportation of the machine in the distance between the rows, along national routes and bridges.

It is important to highlight that the maneuverability of harvesting machines in this kind of plantations is hindered by the big size or volume required in view of the size of the trees to be harvested and the small header space, as it usually occurs in most plantations.

### SUMMARY OF THE INVENTION

This patent application relates to a harvesting machine which is capable of reaching the end of the crop row or plantation and performing a wheel turn to allow lateral movement in order to reach adjacent rows without the need of rotating the machine and then move forward, with the help of its reversible feature, in the direction opposite to that of the prior row.

Likewise, said reversible feature allows the harvesting process in the opposite direction which, in addition to the lateral movements to change rows, implies a better utilization of the field surface because the size of the header can be diminished.

In order to obtain a reversible machine, i.e. a machine that is able to harvest in opposite directions, many of the elements of this machine need to be capable of reversing the turning direction when the forward or harvest direction of the harvesting machine is changed.

In addition, the particular configuration of this machine will enable transportation thereof in carts along national routes, and the user will not have to resort to extendable or telescopic devices such as those known for the heavy harvesters of the prior art.

The machine of the present invention allows for an efficient harvest, preferably of oranges and especially in large plantations such as those existing in the US and Europe, and in such other places where the high price of land calls for the maximum land development.

As stated above, the harvesting machine of this invention shall have a significant size because the trees have big dimensions during production or harvesting season, being the size of a preferred embodiment around 9 meters long, 4 meters wide and 4.5 meters high. Likewise, the harvesting machine of this invention should be as light as possible to avoid root compacting; it should be agile so that it can adapt to the shape of the land and turn in the small header spaces and finally collect the largest amount of fruits (over 85%) possible without damaging the tree, to then place them in collection bins or carts for further industrialization.

Tests performed with machines bearing the features and sizes described above allowed for the perfect and thorough harvesting of 5-meter header plantations.

Another purpose of the present invention is the method for harvesting and/or moving along the crop rows by the reversible harvesting machine of the present invention.

The fruits are Knocked down by shaking “fingers on the tree branches”, which system has been largely disclosed in the patents of the prior art mentioned above.

The harvesting machine of the present invention moves in the following stages, during harvesting process:
a) it moves forward in a first direction along the row of trees to be harvested,
b) when the machine reaches the end of the row or the last tree of the row, it rotates its wheels towards the row of trees that has not been harvested yet substantially at a 90-degree angle to allow for the change of row;
c) it brings the wheels back to the position prior to rotation described in stage “b”;
d) it reverts the turn of the wheels so as to move the machine forward in the direction opposite to that of the prior adjacent row;
e) it repeats stages “b” through “d” when it reaches the end of the new row.

It is understood that, if necessary, the harvesting machine is able to come and go along the same row as many times as required without the need to perform any turning maneuver.

As it may become apparent, the solution to this drawback is given by the possibility of changing the wheels 90 degrees at the end of the row or header, perform the turning maneuver or rotate the wheels to allow the machine to move laterally from a row to an adjacent row and then move in the opposite direction.

In order to have the systems or gears operate in both directions and thus perform harvesting in the desired direction, proportional hydraulics and automation systems such as PLC programmers have been used.

The use of state-of-the-art technologies, such as proportional hydraulics, allows controlling the travel and harvesting speeds according to the trees yield rates. Automation systems, such as PLC programmers, will allow monitoring and commanding all the harvesting machine systems from a display located in the driver's cab. The use of electronic elements will assure the maximum operating efficiency of all systems involved.

As anyone skilled in the art may notice, the use of a turning system that allows moving the harvesting machine 360 degrees together with the reversibility feature of the machine described in the present invention, allow for the use and development of heavy machines (riding or lateral among others) and this provides significant operating advantages relative to the use of the machines existing today, and means less operators and fuel; therefore, this harvesting machine may be operated in intensive plantations (reduced inter-row distance) and/or with little space in headers, and less damages is caused to the plants and the land is less compacted; additionally, the trunk of the plant and/or the roots of the trees are not damages by the vibration, as in other harvesting devices that are based on this vibration principle.

Another important characteristic of the harvesting machine of this invention that provides for the necessary conditions to achieve reversibility features is the control cab. Said cab is located on one side of the machine and is comprised by two seats, one of them swivels and the other one slides perpendicularly to the direction in which the harvesting machine moves forward.

The swivel seat shall be taken by the driver who will be in charge of driving the machine along the rows of trees to be harvested. The swiveling motion of said seat allows adopting different positions relative to the forward movement or harvest direction of the harvesting machine.

The second seat is taken by a second person in charge of supervising the harvesting or knocking down of fruits in the tree rows. This seat sliding perpendicularly to the movement of the harvesting machine will avoid reducing driver's visibility. If the seat were not capable of sliding as described above, the harvesting machine driver would have a poor visibility in certain maneuvers or forward directions and would be facing his fellow worker.

### BRIEF DESCRIPTION OF THE DRAWINGS

For a better understanding of the present invention and of the advantages described above, in addition to those that those skilled in the art may include, a detailed description of the some preferred embodiments of this invention is made, based on the enclosed drawing, wherein:

FIG. 1 shows a lateral overview of the harvesting machine of the present invention;

FIG. 2 is a front view of the harvesting machine of the present invention;

FIG. 3 is a rear view of the machine of the present invention;

FIG. 4 is a plan view of the harvesting machine of the present invention;

FIG. 5 is a first front perspective view of the reversible machine of the present invention.

FIG. 6 is a first side perspective view of the reversible machine of the present invention;

FIG. 7 shows a perspective view that illustrates the gear that produces the turn of the wheels to allow for the lateral movement of the harvesting machine of the present invention;

FIG. 8 is a perspective view of a portion of the harvesting machine where you can see the 90-degree turn relative to the position of the wheels in FIG. 7;

FIGS. 9a, 9b, 9c and 9d are the different positions of the wheels and the cylinders that actuate them during whole turning process;

FIG. 10 shows the harvesting method to be performed by the machine described in the Figures above;

FIG. 11 is a first perspective view of one of the bogies of the present invention;

FIG. 12 is a second perspective view of the bogie of FIG. 11;

FIG. 13 is a perspective view of the component parts of the bogie of FIGS. 11 and 12;

FIGS. 14a, 14b, 14c and 14d are perspective views of some of the elements that comprise the bogie of the above figures.

### DETAILED DESCRIPTION OF THE PREFERRED EMBODIMENTS

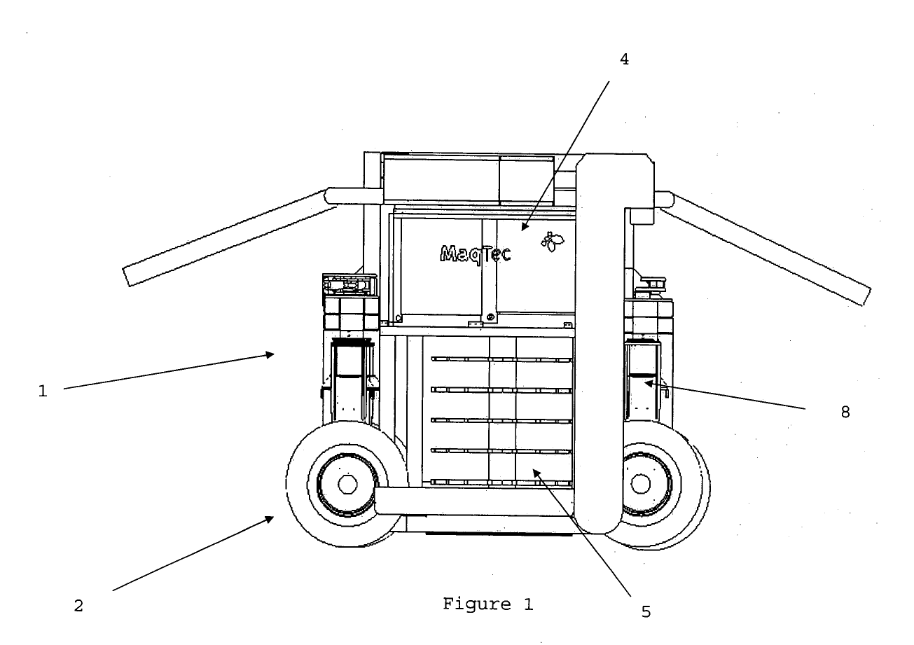

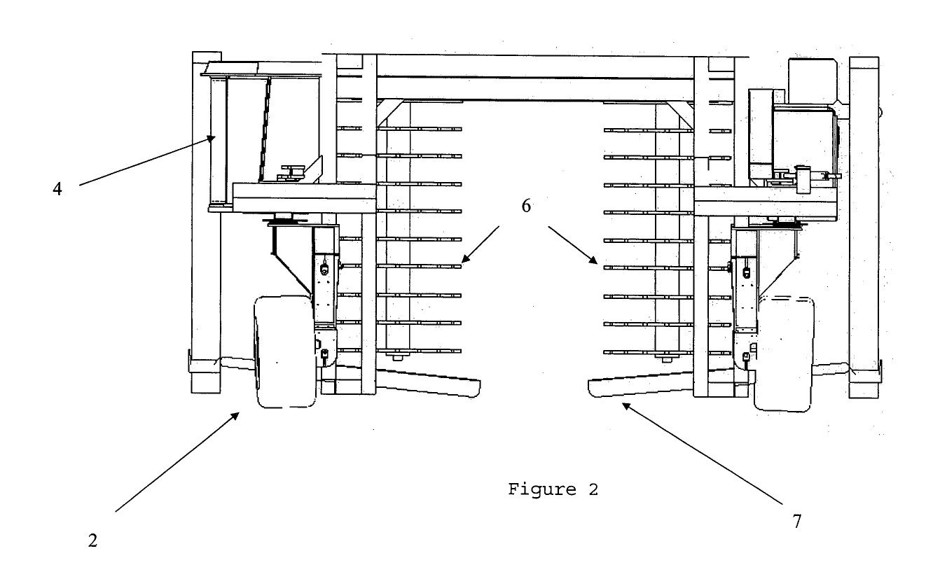

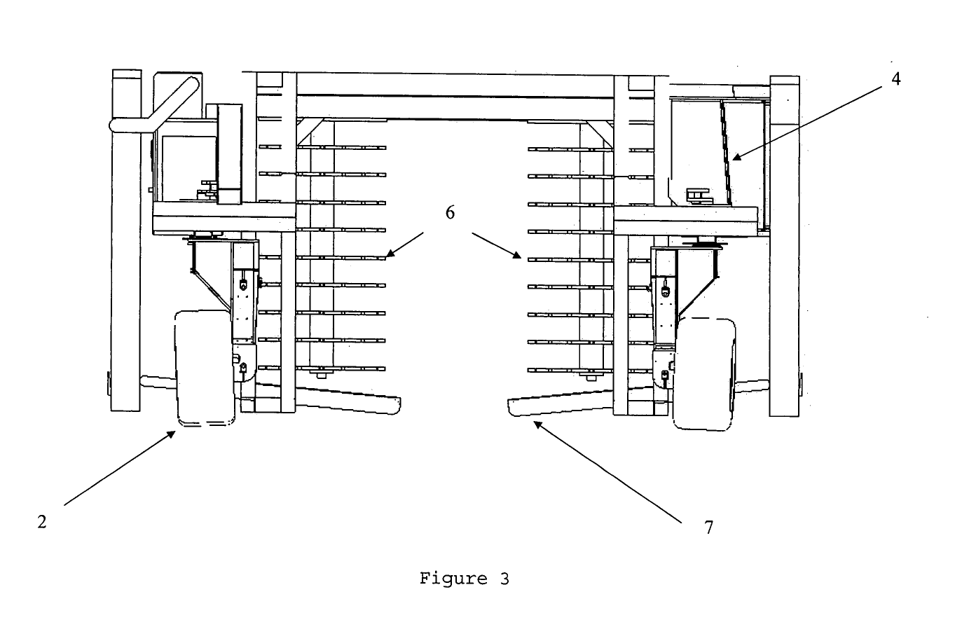

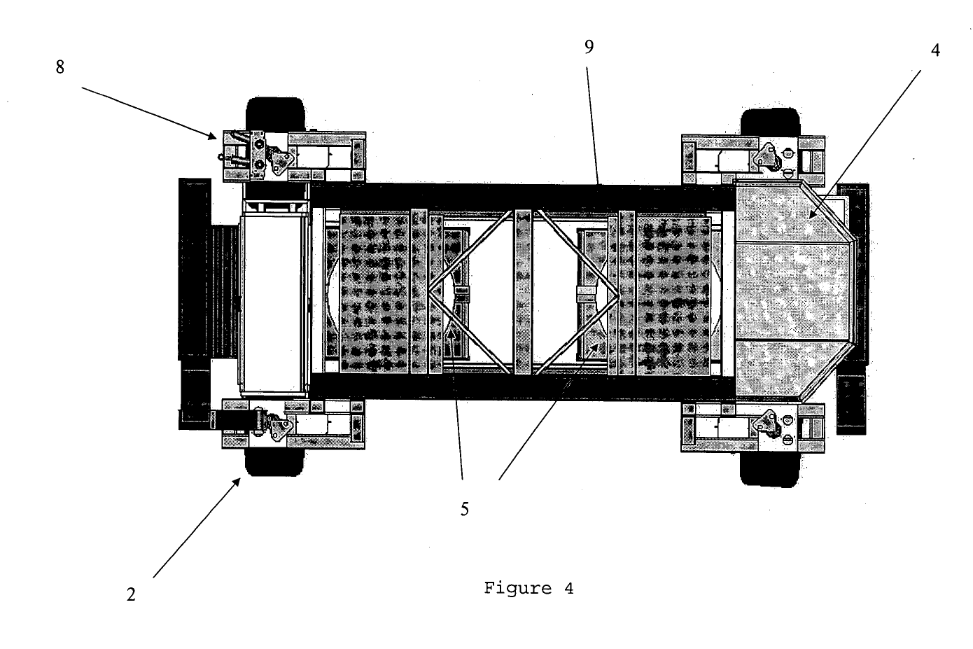

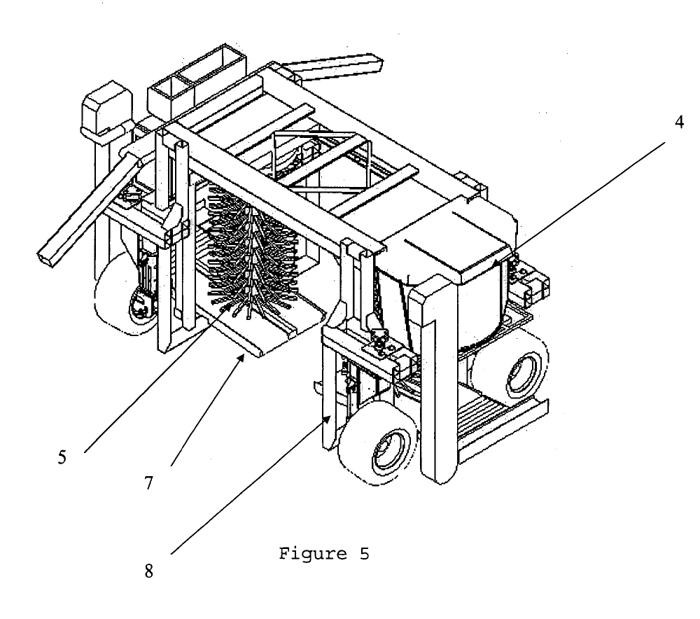

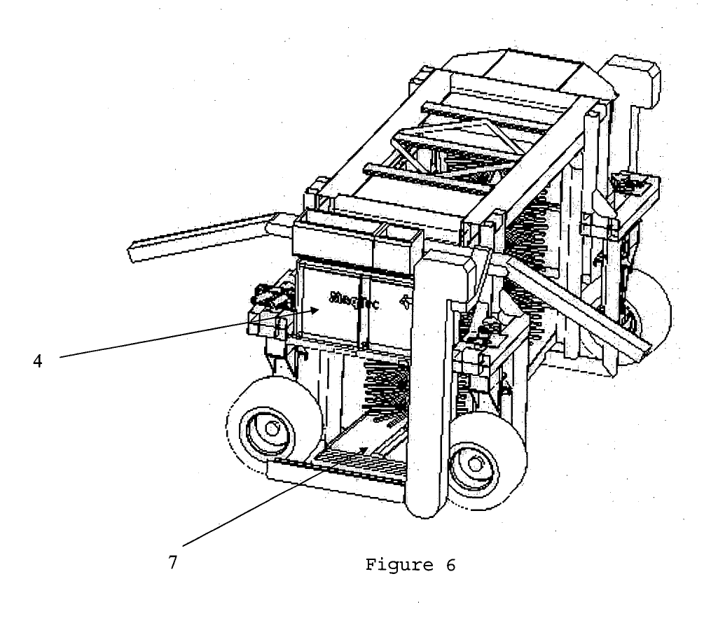

FIGS. 1 though 6 show a reversible, riding harvesting machine 1, which comprises moving means 6, wheels 2, a chassis 3, an operator cab 4, two rotating headstocks 5, supporting devices for fingers 6 that are capable of getting in contact with the branches of the trees to be harvested, respective collection trays 7 located under the rotating headstocks and the supporting and frame and actuating structure 8 of wheels 2.

As shown in FIG. 7, the bogie 11 containing wheel 2 is rotated by means of cylinders 9 and 10, which are centrally attached to an integral part of the machine frame, and coupled at one end to a steering arm 12 that will spin when cylinders 9 and 10 rotate and will ultimately provoke the rotation of wheel 2. The wheel's turning angle shall be in terms of the expansion of each arm of cylinders 9 and 10.

FIG. 8 shows the turn made by the bogie 11 as a result of the actuation of cylinders 9 and 10.

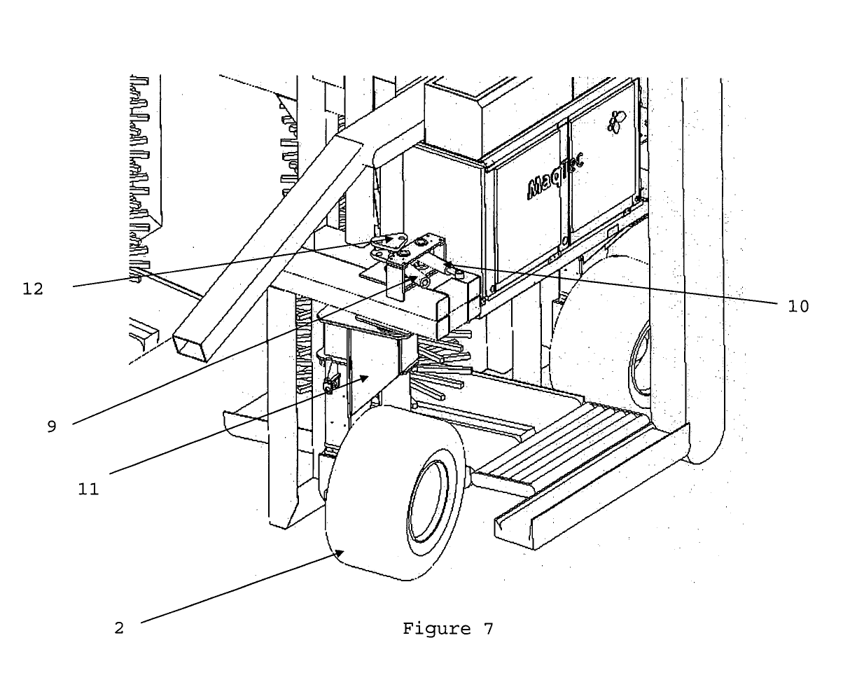

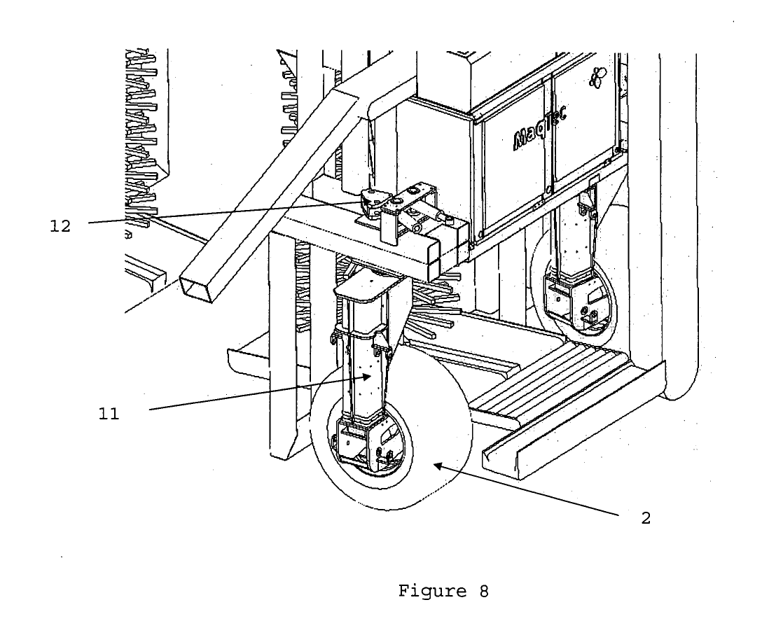

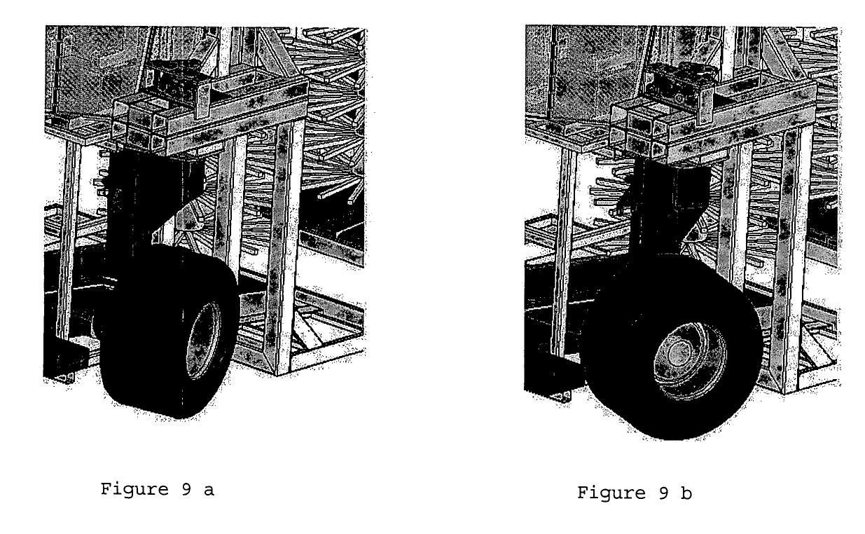

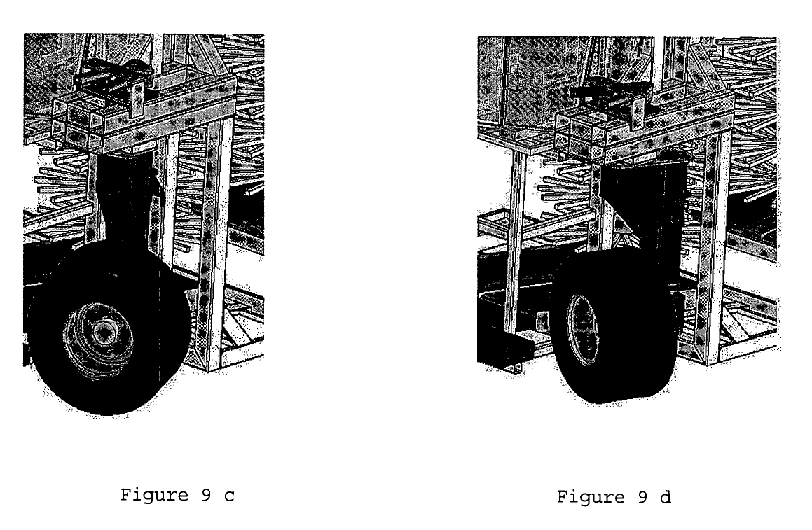

FIGS. 9a, 9b, 9c and 9d, clearly show the stages of turn in the different positions adopted by the harvesting machine wheel as a result of the actuation of cylinders 9 and 10.

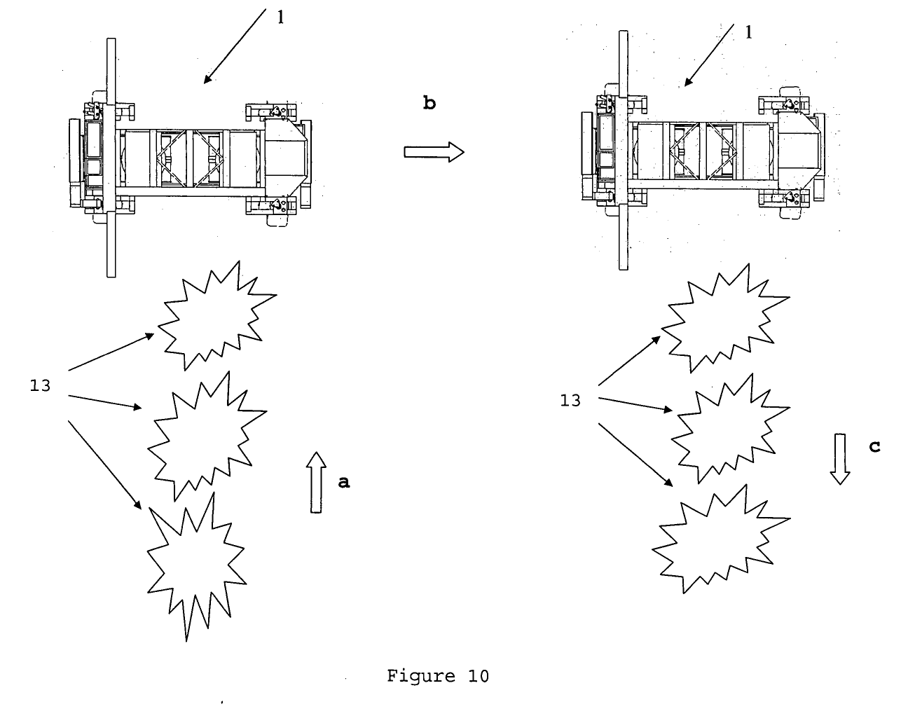

During the operative stage and as shown in FIG. 10, the reversible harvesting machine of the present invention moves forward according to arrow “a” along the row of orange trees 13 and when it reaches the end of the row, its right wheels make a 90° turn; subsequently and before actuating the hydraulic engine of the wheel, it turns the wheels and causes the machine to move to the right adjacent row (arrow “b”).

When the machine is placed in said adjacent row, it moves its wheels to the prior position and changes the direction of the turn (arrow “c”) so that the machine continues harvesting until the end of said row.

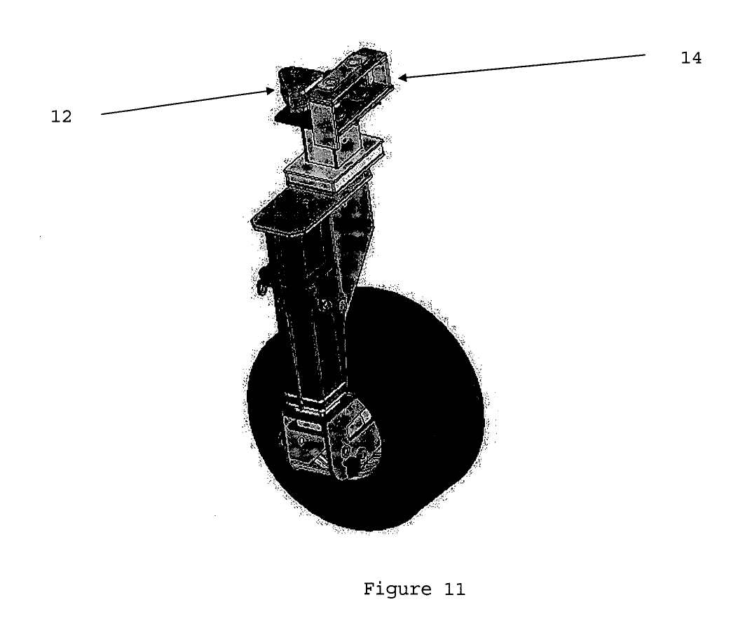

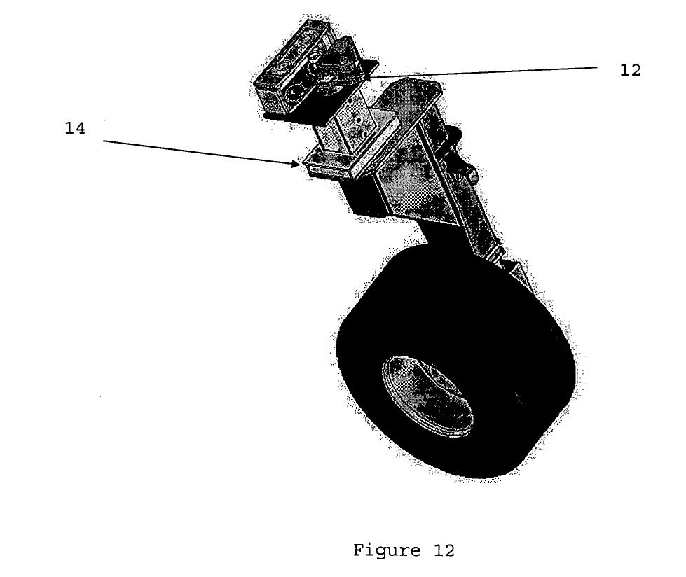

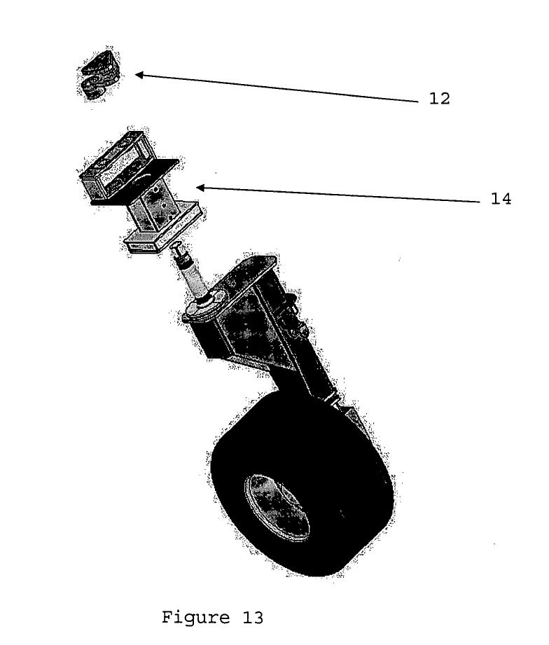

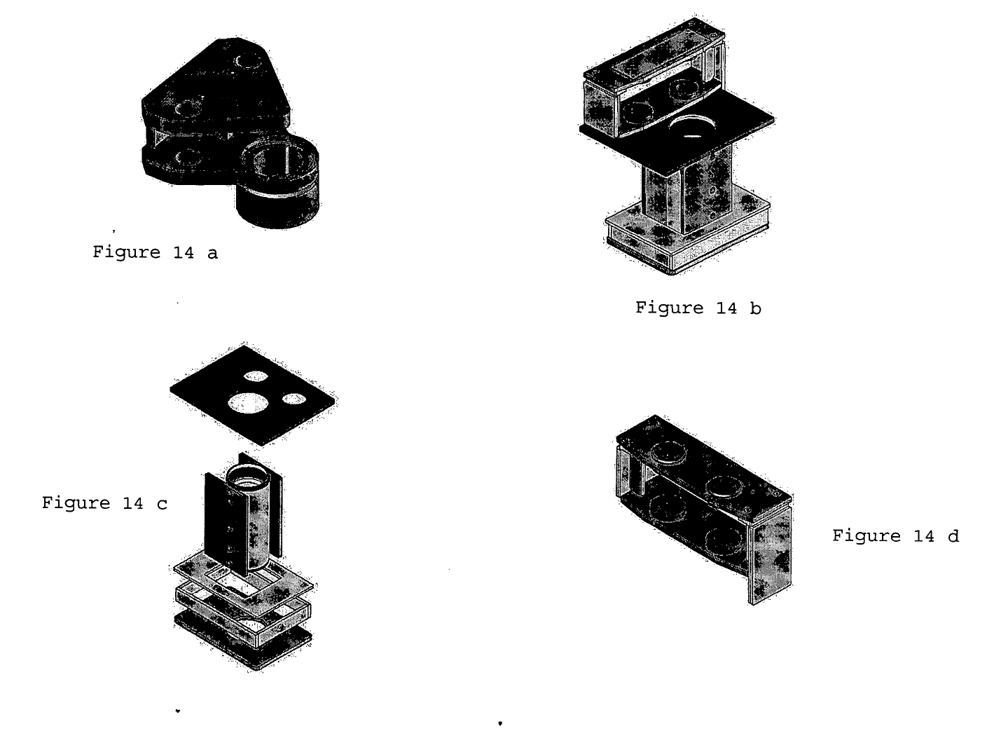

FIGS. 11, 12, 13 and 14a, 14b, 14c and 14d show the preferred embodiment of the bogie applied to the turn of the wheels of this invention, and the structure of each one of the elements that comprise it; they show the steering arm 12 together with the support 14 of cylinders 9 and 10.

In order to allow the harvesting machine of this invention to work in the same way in opposite directions after the change of direction made in each header, and thus make use of the novel reversible feature proposed in this invention, some of the gears of this harvesting machine are capable of inverting the turn direction. This distinctive feature may be applied for instance to the headstocks supporting the fingers and fruit conveyor belts, which will turn or move in the opposite direction when the forward direction of the harvesting machine changes.

Preferably, the harvesting machine of this invention has a mounting bodywork on its chassis that contains harvesting headers that move closer to or farther away from one another, as described in US 20050034441.

Likewise, the invention will preferably have four wheels that have a motion and steering system based on cylinders and hydraulic engines that are electronically operated in a coordinated manner by a computer program that allows the machine to travel in any direction, around 360 degrees (“crab”-like movement), interchanging functions between directional and correction axles, and thus defining a reversible harvesting position, a traveling position and a “crab -like movement. The term “crab“-like movement refers to the capacity of four wheels to move at the same angle and in the same direction.

In view of the above, we believe that the description of our invention is thorough and absolutely clear for anyone skilled in the art.

I claim:

1. A reversible, directable harvesting machine comprising:
a chassis;
a cab connected to the chassis;
said cab having a first seat capable of swiveling and a second seat capable of sliding;
said first seat and second seat both capable of adjusting to the direction of movement of the harvesting machine;
a plurality of wheels connected to the chassis to move the chassis;
said plurality of wheels being capable of rotating in order to enable the chassis to move in laterally; and
a gear connected the plurality of wheels to drive said plurality of wheels;
said gear being capable of driving said plurality of wheels in any direction.

2. A harvesting machine according to claim 1;
wherein each one of said plurality of wheels has a gear, actuated by a couple of cylinders, that can extend and retract in a coordinated manner;
wherein said gears allows for the rotation of said plurality of wheels at an angle of 90° or more.

3. A harvesting machine according to claim 1;
wherein the chassis supports a riding frame that holds two harvesting headers;
wherein the two harvesting headers are capable of withdrawing from one another and moving toward one another.

4. A harvesting machine according to claim 1 further comprising a motion and steering system;
the motion and steering system comprising cylinders and hydraulic engines;
wherein the cylinders and hydraulic engines are electronically operated in a coordinated manner by a computer program;
the computer program enabling the harvesting machine to move in a crab-like fashion by allowing the machine to travel in any direction.

5. A method for carrying out a harvesting process with a reversible, directable harvesting machine,
said harvesting machine comprising
a chassis;
a cab connected to the chassis;
said cab having a first seat capable of swiveling and a second seat capable of sliding;
said first seat and second seat both capable of adjusting to the direction of movement of the harvesting machine;
a plurality of wheels connected to the chassis to move the chassis;
said plurality of wheels being capable of rotating in order to enable the chassis to move in laterally; and
a gear connected the plurality of wheels to drive said plurality of wheels;
said gear being capable of driving said plurality of wheels in any direction;
the method comprising the steps of:
a) moving the harvesting machine in a first direction along a row of trees to be harvested;
b) rotating the plurality of wheels at no less than a 45 degree angle towards a next row of trees to be harvested;
c) moving the harvesting machine in a second direction towards the next row of trees to be harvested;
d) returning the rotation of the plurality of wheels back to the position prior to rotating step; and
e) moving the harvesting machine in a third direction along the next row of trees to be harvested;
said third direction being opposite to that of the first direction.

6. A method for carrying out a harvesting process with a reversible, directable harvesting machine, the method comprising the steps of:
a) moving the harvesting machine in a first direction along a row of trees to be harvested;
b) moving the harvesting machine in a second direction towards a next row of trees to be harvested;
said second direction being at no less than a 45 degree angle to the first direction;
c) moving the harvesting machine in a third direction along the next row of trees to be harvested;
said third direction being opposite to that of the first direction.
